(19) United States
(12) Patent Application Publication
(10) Pub. No.: US 2026/0238868 A1
(43) Pub. Date: Aug. 13, 2026

(54) SELF-CONFIGURING MODULAR MATERIAL HANDLING SYSTEMS AND METHODS

(71) Applicant: Robotica, Inc., Cypress, TX (US)

(72) Inventor: Jay M. Dugat, Cypress, TX (US)

(73) Assignee: Robotica, Inc., Cypress, TX (US)

(21) Appl. No.: 19/533,169

(22) Filed: Feb. 7, 2026

Related U.S. Application Data
(60) Provisional application No. 63/756,138, filed on Feb. 8, 2025.

(51) Int. Cl. H04N 23/54

(52) U.S. Cl. CPC H04N 23/54

(57) ABSTRACT

A material handling system with a base to integrate material handling modules. Each module housing a motor correlated to data associated to the function of the module. A processor with instructions to: a) recognize the data correlated to each motor in each module; b) process the recognized data to identify the function of each respective module; and c) enable actuation of each module based on the identified module function. The base configured with a communication network to permit data transfer between the processor and each module. The processor configured to automatically perform the instructions (a)-(c) when a material handling module is integrated onto the base. A method for handling materials. A system with a base and a material handling module consisting of a conveyor module with a belt and a camera beneath a conveyance surface in a void in the conveyor belt to image materials on the surface.

### CROSS-REFERENCE TO RELATED APPLICATIONS

This application claims priority from U.S. Provisional Application No. 63/756,138 filed on Feb. 8, 2025, incorporated herein by reference in its entirety.

### FIELD OF THE INVENTION

The present disclosure relates generally to technology for automated systems for handling materials, such as parcels and goods.

### BACKGROUND

The parcel-handling industry is experiencing rapid growth, fueled by the exponential increase in e-commerce. However, conventional conveyor and sortation solutions face several limitations, including high upfront costs, prolonged deployment times, and a lack of scalability. This has hindered widespread adoption, particularly among small and medium-sized operations.

Many existing sortation operations predominantly rely on manual labor, accounting for a large portion of the warehousing expenses. These manual operations are further strained during seasonal peaks, leading to inefficiencies, temporary workers, higher error rates, and increased costs. Current automated systems are often costly, complex to install, and not adaptable to the diverse parcel types handled in modern logistics.

The market for parcel conveyor and sortation systems has a significant unmet need for cost-effective, rapidly deployable, and scalable solutions. Operators require systems that integrate seamlessly with existing infrastructure, provide high accuracy and reliability, and deliver a fast return on investment. Furthermore, portability and modularity are critical for handling changing operational demands and maximizing utilization.

FIG. 1 shows a conventional belt conveyor sorting assembly 10 configured by placing two separate units side-by-side, producing a wide transition gap 11 along the belt conveyor zone 12. Such transition gaps 11 create catch points or traps for small cylindrical objects in non-rigid packaging (such as polybags) that stop or impede parcel flow, creating missed sorts. These assemblies 10 have separate leg sets 13, which make it difficult to maintain a level surface if one unit is offset from the other. As shown in FIG. 1, some conventional assemblies 10 are also equipped with one or more cameras 14. However, the cameras 14 are typically mounted close to the conveyor zones 12 and above the belt, which create additional impediment or snag points for parcels extending over the edge of the conveyor belts and fail to “see” very flat objects. FIG. 2 shows a perspective view of one of the leg sets 13. The leg 13 consists of individual side segments 15 coupled together and braced by one or more cross rails 16. The side segments 15 are configured with predrilled holes 17 to receive bolts 18 that sustain the cross rails 16 and the individual side segments. U.S. Pat. No. 10,654,659 proposes a conveyor control system using a network of controllers disposed on conveyor stations and limited to motor controls.

A need remains for improved techniques for materials conveyance and sorting, specifically addressing challenges in mobility, transportability, deployment, and configuration.

### SUMMARY

A material handling system according to an aspect of this disclosure includes a base configured to integrate a plurality of material handling modules. Each module houses at least one motor correlated to digital data uniquely associated to the function of the respective module. At least one processor configured with instructions to: a) recognize the digital data correlated to each at least one motor in each module; b)process the recognized digital data to identify the function of each respective module; and c) enable actuation of each module based on the identified function of the respective module. The base is configured with a communication network to permit digital data transfer between the at least one processor and each material handling module, wherein the at least one processor is configured to automatically perform the instructions (a)-(c) when a material handling module is integrated onto the base.

A method for handling materials according to an aspect of the invention includes integrating a plurality of material handling modules onto a base, wherein each material handling module houses at least one motor correlated to digital data uniquely associated to the function of the respective module; using at least one processor configured with instructions to: a) recognize the digital data correlated to each at least one motor in each module; b) process the recognized digital data to identify the function of each respective module; and c) enable actuation of each module based on the identified function of the respective module; providing a communication network on the base to permit digital data transfer between the at least one processor and each material handling module; and automatically performing the instructions (a)-(c) via the at least one processor when a material handling module is integrated onto the base.

A material handling system according to another aspect of this disclosure includes a base configured with at least one material handling module consisting of a conveyor module. The at least one conveyor module is configured with: a single continuous conveyor belt to provide a conveyance surface to move materials disposed thereon; and a camera is disposed beneath the conveyance surface to provide an unobstructed conveyance path and image materials disposed on the conveyance surface without limitation of the height of the materials. The camera is disposed in a void formed in the single continuous conveyor belt.

A material handling system according to another aspect of this disclosure includes a plurality of independent material handling modules. A base is configured to receive the plurality of modules, and at least one processor is configured with instructions to identify the function of each respective module of the plurality of material handling modules to enable plug-and-play integration of the plurality of modules onto the base.

### BRIEF DESCRIPTION OF THE DRAWINGS

The following figures should not be used to limit the claimed subject matter. The claimed subject matter may be better understood by reference to one or more of these drawings in combination with the description of embodiments disclosed herein. Consequently, a more complete understanding of the present embodiments and further features and advantages thereof may be acquired by referring to the following description taken in conjunction with the accompanying drawings, in which like reference numerals may identify like elements.

FIG. 1 shows a schematic of a conventional belt conveyor sorting assembly.

FIG. 2 shows a schematic of a conventional base frame leg.

FIG. 3 shows a perspective view of base unit according to an example of the present disclosure.

FIG. 4A shows a close-up view of a base structure in a pre-engaged position according to an example of the present disclosure.

FIG. 4B shows a close-up view of the base structure of FIG. 4A in an engaged position according to an example of the present disclosure.

FIG. 5A shows a cross-section of an initial position for a backplate insertion within a frame member channel according to an example of the present disclosure.

FIG. 5B shows a cross-section of the backplate of FIG. 5A in an intermediate insertion position within a frame member channel.

FIG. 5C shows a cross-section of the backplate of FIG. 5A in a final inserted position within a frame member channel.

FIG. 6 shows a close-up schematic of a wheel engagement with a frame member according to an example of the present disclosure.

FIG. 7 shows an end view of the wheel engagement of FIG. 6.

FIG. 8 shows the assembly of FIG. 6 in engagement with a frame member according to an example of the present disclosure.

FIG. 9 shows a close-up schematic of a leveling foot according to an example of the present disclosure.

FIG. 10 shows a close-up schematic of the leveling foot of FIG. 9 in a frame member engagement position according to an example of the present disclosure.

FIG. 11 shows a perspective schematic of a frame member and coupling member according to an example of the present disclosure.

FIG. 12 shows a close-up schematic of a frame member backplate engagement assembly according to an example of the present disclosure.

FIG. 13 shows a close-up schematic of another frame member backplate engagement assembly according to an example of the present disclosure.

FIG. 14 shows a partial section of a base unit according to an example of the present disclosure.

FIG. 15 shows a perspective view of a material handling system with multiple material handling modules suspended above a base according to an example of the present disclosure.

FIG. 16 shows a perspective view of another material handling system with multiple material handling modules integrated onto the base according to an example of the present disclosure.

FIG. 17 shows a cross-section side view of a conveyor module according to an example of the present disclosure.

FIG. 18 shows a cross-section side view of a conveyor module assembly according to an example of the present disclosure.

FIG. 19 shows a perspective view of a continuous conveyance surface of a material handling system according to an example of the present disclosure

FIG. 20 shows a schematic of a conventional parcel sorting station.

FIG. 21 shows a schematic view of another material handling system according to an example of the present disclosure.

FIG. 22 shows a side view of another material handling system according to an example of the present disclosure.

FIG. 23 shows an elevated perspective view of the material handling system of FIG. 22.

FIG. 24 shows an overhead view of the material handling system of FIG. 22.

FIG. 25 shows a perspective view of another material handling system according to an example of the present disclosure

FIG. 26 shows a schematic of another material handling system according to an example of the present disclosure.

FIG. 27 shows a side view schematic of the material handling system of FIG. 26.

FIG. 28 shows another side view schematic of the material handling system of FIG. 26.

FIG. 29 shows a perspective view of another material handling system according to an example of the present disclosure.

FIG. 30 shows a side view of the material handling system of FIG. 29.

FIG. 31 shows an elevated perspective view of the material handling system of FIG. 29.

FIG. 32 shows an overhead perspective view of the material handling system of FIG. 29 in a working environment.

FIG. 33 shows another perspective view of the material handling system of FIG. 32.

FIG. 34 shows an overhead view of the material handling system of FIG. 32.

FIG. 35 shows a perspective view of a multi-base material handling system according to an example of the present disclosure.

FIG. 36 shows another perspective view of the multi-base material handling system of FIG. 35.

FIG. 37 shows an overhead schematic view of another material handling system according to an example of the present disclosure.

FIG. 38 shows an architecture and process flow chart according to an example of the present disclosure.

### DETAILED DESCRIPTION

The foregoing description of the figures is provided for the convenience of the reader. It should be understood, however, that the embodiments are not limited to the precise arrangements and configurations shown in the figures. The figures are not necessarily drawn to scale, and certain features may be shown exaggerated in scale or in generalized or schematic form, in the interest of clarity and conciseness. It will be understood that the word “camera”, as used herein, is meant to include all imaging devices capable of detecting, recording, and/or transmitting optical data in all spectrums as known in the art (e.g., code readers, scanners, thermal imaging, etc.). It will also be understood that as used herein, “microprocessors” are intended to be interchangeable with “firmware”, and all such devices are to be construed under the general category of electronics.

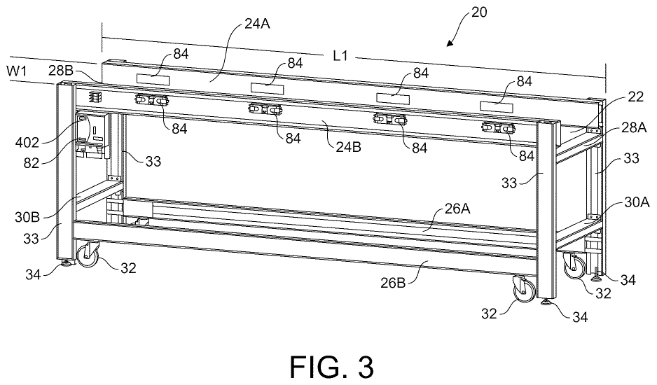

FIG. 3 shows an embodiment of a power base 20 of this disclosure. The base 20 may be implemented as a substrate structure designed to serve as a versatile foundation for integrating material handling modules (further describe below). Base 20 embodiments provide a stable platform 22 to support the modules at the required operating heights or slopes for optimal sorting configurations as desired by operators. In addition to structural support, base 20 embodiments may be configured to deliver power, power distribution, controls, and communication connections necessary for module operation using conventional components as known in the art. FIG. 3 shows a base 20 embodiment configured with a pair of elongated upper side rails 24A, 24B and elongated lower side rails 26A, 26B. Upper 28A, 28B and lower 30A, 30B end rails are coupled onto the structure to form a stable base 20. It will be understood that electrical power to the base 20 embodiments may be provided via conventional cables and power converters to connect to a local power source as known in the art. The disclosed base 20 embodiments also present an overall reduced physical footprint compared to conventional stations. Base embodiments 20 may be implemented in any suitable dimensions to accommodate the working needs and environment. For example, FIG. 3 shows a base 20 produced at a length L1 of 7.5 feet (2.29 m) and width W1 of 3 feet (0.9 m).

FIG. 3 shows a base 20 embodiment implemented with a rectangular frame structure. It will be appreciated that other embodiments may be implemented in different physical configurations (e.g., squared) via use of different sized rails 24A, 24B, 26A, 26B, 28A, 28B, 30A, 30B in construction of the base 20. The base 20 embodiment of FIG. 3 is equipped with wheels 32 affixed to the lower side rails 26A, 26B. In this embodiment, the side rails 26A, 26B are configured to be raised and lowered, thereby respectively raising and lowering the wheels 32 to facilitate rolling movement of the base 20 to different locations and setting of the base in a desired location. Each leg 33 of the base 20 is implemented with a leveling foot 34 for adjustment of the base once the wheels 32 are raised and the base is set in place. Other base 20 embodiments may be implemented with wheels 32 or coasters linked to the structure in various ways to enable rapid mobility of the base when desired. For example, a base 20 embodiment may be implemented with spring-loaded wheels 32 configured to extend out from and retract within cavities formed at the lower end of the base legs 33 (not shown).

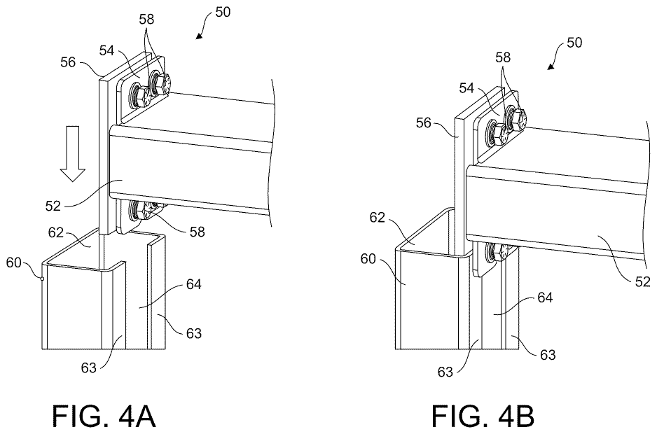

FIG. 4A shows a close-up view of a structural frame connection 50 embodiment of this disclosure in a pre-engaged position. A cross member 52 is configured with a flat end plate 54 that mates against a pre-threaded backplate 56. Bolts 58 passing through the end plate 54 engage with the threaded holes in the backplate 56 to secure the two plates against one another. A frame member 60 is configured with an enclosed channel 62 having planar walls, with one wall surface 63 having a slot 64 formed along its longitudinal axis to provide a passthrough for the bolts 58 on the end plate 54 when the backplate 56 is slid into the channel 62 of the frame member 60 (in the direction of the arrow in FIG. 4A).

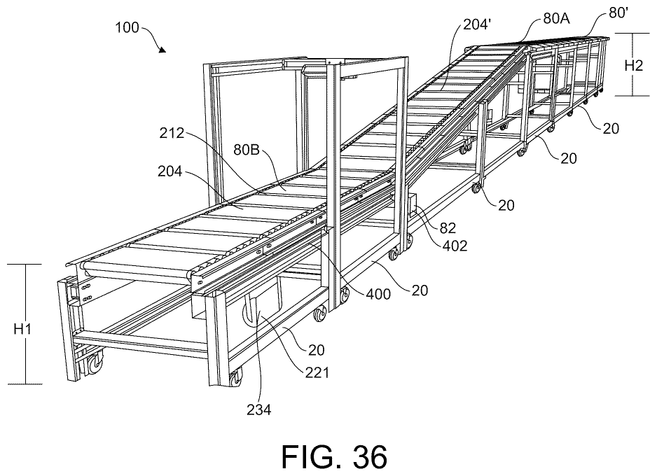

FIG. 4B shows the frame connection 50 in the engaged position. Once the backplate 56 is disposed in the channel 62 of the frame member 60, the cross member 52 can slide along slot 64 to the desired position. To secure the cross member 52 in place, the bolts 58 are tightened to clamp the backplate 56 against the wall surfaces 63 on the sides of the slot 64 on the frame member 60. This frame connection 50 embodiment enables the members 52, 60 to be moved and set at variable attachment points, allowing fine adjustments for positioning, leveling, squaring, and plumbing of the base 20 and system 100 (see e.g., FIG. 36) structural components.

The structural elements (e.g., members 52, 60) of the base 20 embodiments disclosed herein can be fabricated with a conventional Press Brake that forms the shape in its actual length. In contrast, conventional frame products (e.g., leg 13 in FIG. 2) are manufactured in a continuous forming operation that cuts the length after the forming process. Producing structural elements (e.g., members 52, 60) with a Press Brake enables lower upfront costs and easy modifications on the fly, which are difficult and costly with conventional fixed-die processes. Use of a Press Brake in the production of the disclosed system 100 frame elements also enables fabrication of the enclosed channel 62 design.

As shown in FIGS. 4A and 4B, frame connection 50 embodiments can be implemented with a fastening system using multiple fasteners (bolts 58) to provide the necessary force to clamp the end plate 54 toward the backplate 56. The use of multiple fasteners 58 provides a planar clamping force rather than a point force created in single or dual bolt systems (e.g., bolt 17-hole 18, FIG. 2) that tend to “pucker” the holes when over-torqued, destroying the retaining capacity and ability to resist rotation of the structure around the connection point. The disclosed planar frame connections 50 enable application of very large clamping forces without damaging the structural members or requiring added reinforcement (e.g., sheet metal) to connection point surfaces, keeping base 20 weight and cost down. Additionally, the base 20 embodiments can be configured such that all of the structural elements can be assembled, adjusted, and leveled with one nut-running tool.

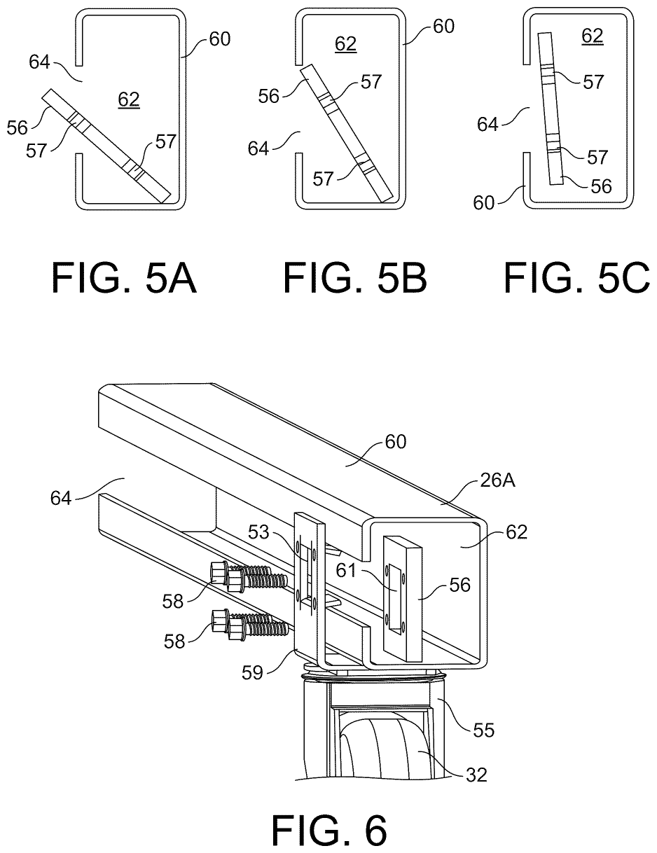

FIG. 5A show a cross-section of a backplate 56 in an initial position being inserted within the channel 62 of a frame member 60. FIG. 5B shows the backplate 56 within the channel in an intermediate position. FIG. 5C shows the backplate 56 within the channel 62 in a final position ready to couple with an end plate 54. In the final position, the pre-threaded holes 57 in the backplate 56 are aligned with the slot 64 to receive the engagement bolts 58 (see FIGS. 4A, 4B). Removal of the backplate 56 from within the channel 60 is in the reverse sequence.

FIG. 6 shows a close-up of a wheel 32 engagement with a frame member 60 (e.g., 26A in FIG. 3). In this embodiment, the wheel 32 is mounted on a yoke 55 coupled to an L-shaped plate 59 that abuts against the frame member 60 to provide a mating engagement with a pre-threaded backplate 56 via bolts 58. In some embodiments, the L-shaped plate 59 is formed with an opening 53 in the surface that abuts against the frame member 60, and the backplate 56 is also formed with a corresponding opening 61. As shown in FIG. 6, this wheel-frame connection allows the wheel 32 position to be adjusted along the longitudinal axis of the frame member 60 as desired.

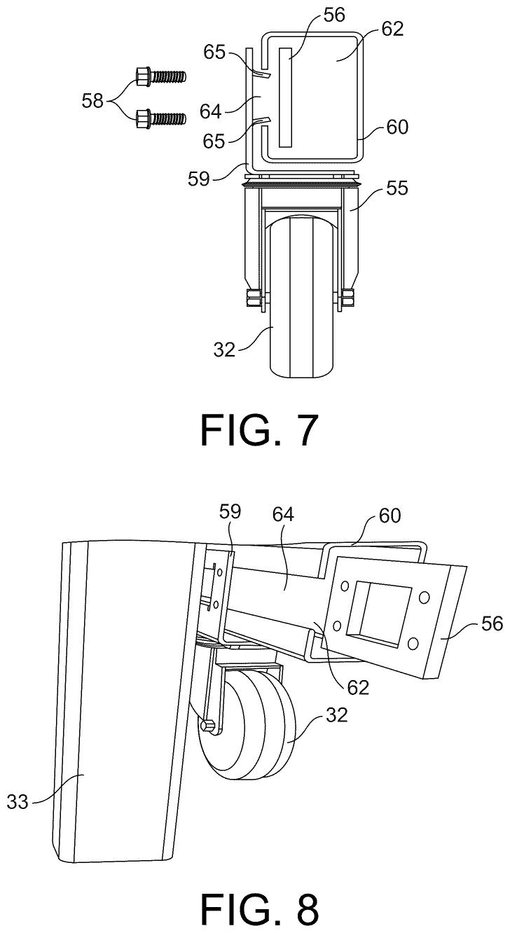

FIG. 7 shows the wheel-frame engagement of FIG. 6 from the end of the frame member 60. In some embodiment, the L-shaped plate 59 is configured with a pair of lips 65 formed at the ends of the opening 53. The lips 65 may be configured from the plate material when the opening 53 is formed on the L-shaped plate 59. In such embodiments, the lips 65 pass through the slot 64 in the frame member 60 and through the opening 61 in the backplate 56 when the L-shaped plate 59 is coupled to the frame member. The lips 53 aid in alignment of the backplate 56 with the L-shaped plate 59 during assembly and facilitate sliding adjustment of the wheel 32 position along the slot 64 in the frame member 60. FIG. 8 shows the assembly of FIG. 7 with the frame member 60 aligned for engagement with a leg 33 frame member (see FIG. 3).

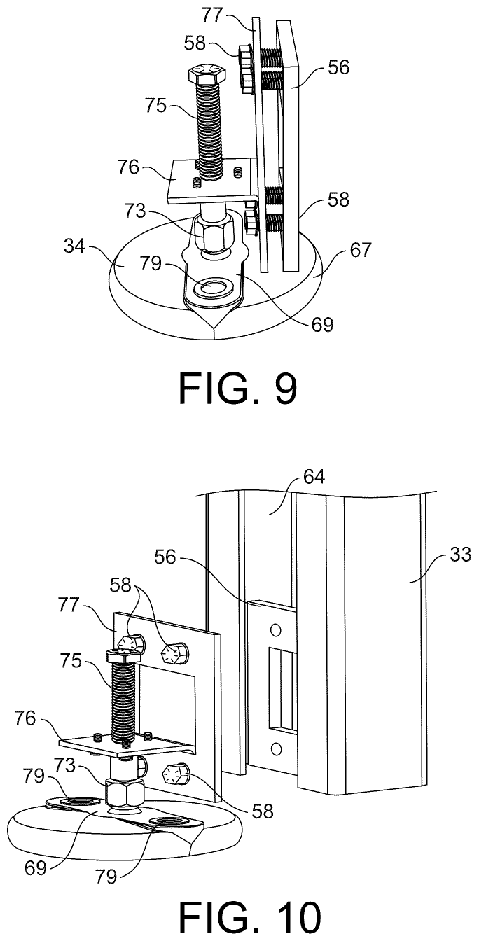

FIG. 9 shows a leveling foot 34 embodiment. The foot 34 is configured with a disc-shaped platform 67 with a flat bottom surface. A bracket 69 is affixed to the upper surface of the platform 67 to provide a rigid support for a nut 73 that receives and secures a height adjustment bolt 75. The bolt 75 passes through a lateral extension 75 stemming off a foot locking plate 77 that aligns with a threaded backplate 56 to be engaged via several bolts 58. The bracket 69 on the platform 67 is also configured with at least one hole 79 that lines up with a hole passing through the body of the platform 67. In applications where the base 20 embodiment needs to be secured in place, conventional fasteners (e.g., stud, bolt, etc.) may be disposed through the holes 79 in the bracket and platform 67 to secure the platform to the ground. Other leveling feet 34 embodiments may be implemented without a hole 79 to receive a fastener. Such embodiments may also be secured in place via other fastening means as known in the art (e.g., welding, adhesives, etc.).

FIG. 10 shows the leveling foot 34 of FIG. 9 in position for engagement to a leg 33 of a base 20 embodiment. As shown, the backplate 56 is disposed within the leg 33 slot 64 and the locking plate 77 is aligned for the bolts 58 to pass through the slot 64 to secure the plate in place against the leg 33 frame member to form a secure frame connection (see FIG. 4B). This configuration permits for dual height adjustment, via the plate-leg frame connection and via the adjustment bolt 75. The platform 67 may be formed of any suitable material (e.g., metal, composites, etc.). In some embodiments, the platform 67 is formed from a suitable rubber or composite compound to provide an electrical insulation barrier between the base 20 and the ground.

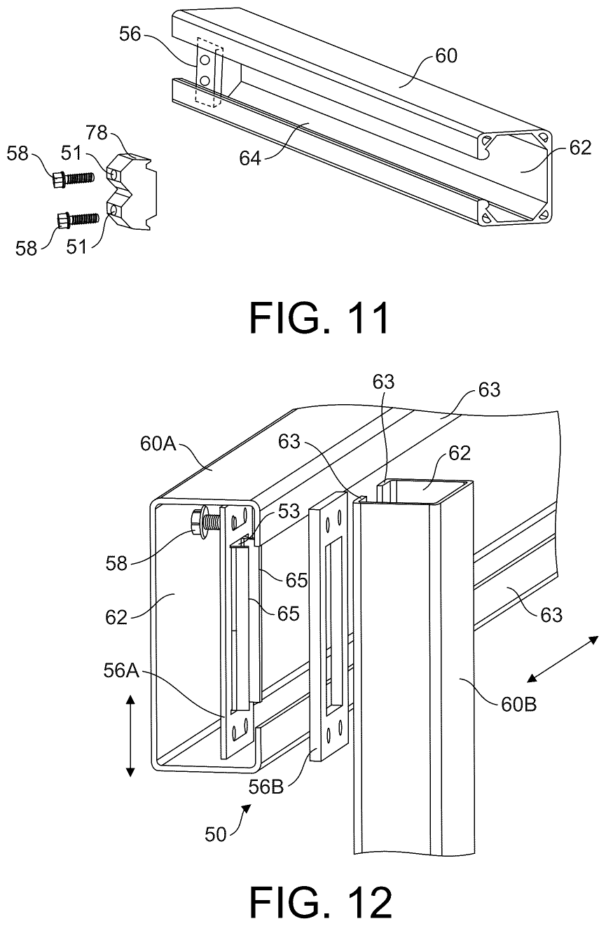

FIG. 11 shows another embodiment of frame member 60 with a threaded backplate 56 disposed within the channel 62 to engage with a retaining cap 78. The cap 78 is configured with holes 51 for bolts 58 to engage the threaded backplate 56. When disposed on a frame member 60, the engaged cap-plate provide a stop or detent along the slot 64 in the frame member. This stop is useful to set a travel limit for moveable items linked with the slot/channel (e.g., linear actuators). The stop also provides a security lock to prevent any frame members 52, 60 from coming loose and inadvertently falling off an end of the frame structure.

FIG. 12 shows another embodiment of a structural frame connection 50. In this embodiment, a first backplate 56A is disposed within the channel 62 of a first frame member 60A. A second threaded backplate 56B is disposed in a second frame member 60B to be coupled to the first frame member 60A. The second backplate 56B is shown outside of the second member 60B channel 62 in FIG. 12 for clarity of illustration. When the first and second frame members 60A, 60B are coupled together, bolts 58 are used to secure the first and second backplates 56A, 56B together. In some embodiment either of the first 56A or second 56B backplates can be configured with a pair of lips 65 extending from the sides of the opening 53, similar to the embodiment of FIG. 7. When the frame connection 50 is secured, the flat mated surfaces 63 of the frame members 60A, 60B in combination with the backplates 56A, 56B provide a secure, robust, and multi-axes adjustable connection. As shown by the respective arrows in FIG. 12, the frame connection 50 allows first frame member 60A to slide up or down along the slot 64 of second frame member 60B and second frame member 60B to slide laterally along the slot 64 of first frame member 60A. This allows one to easily and rapidly make adjustments to the frame structures of the base 20 embodiments.

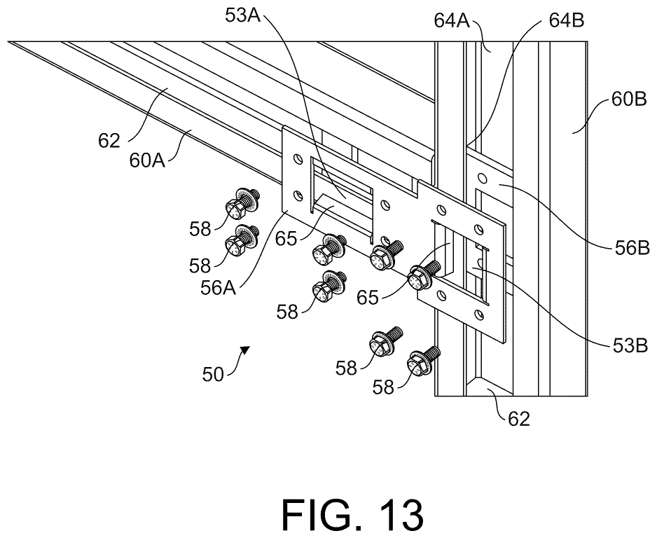

FIG. 13 shows another embodiment of a structural frame connection 50 coupling the end of a first frame member 60A to a second frame member 60B. In this embodiment, the second frame member 60B is configured with a first slot 64A along its longitudinal axis, and a second slot 64B formed at one point along a side wall of the member. An elongated first backplate 56A is used to engage with a matching second threaded backplate 56B disposed in the channel 62 of the first frame member 60A. As shown in FIG. 13, one end of the elongated second backplate 56B is passed through the second slot 64B in second frame member 60B. Once the second backplate 56B is in this position, the two backplates 56A, 56B are engaged with one another via bolts 58 to form a secure connection between the two frame members 60A, 60B. Some backplate embodiments 56A may be configured with lips 65 (see FIG. 12).

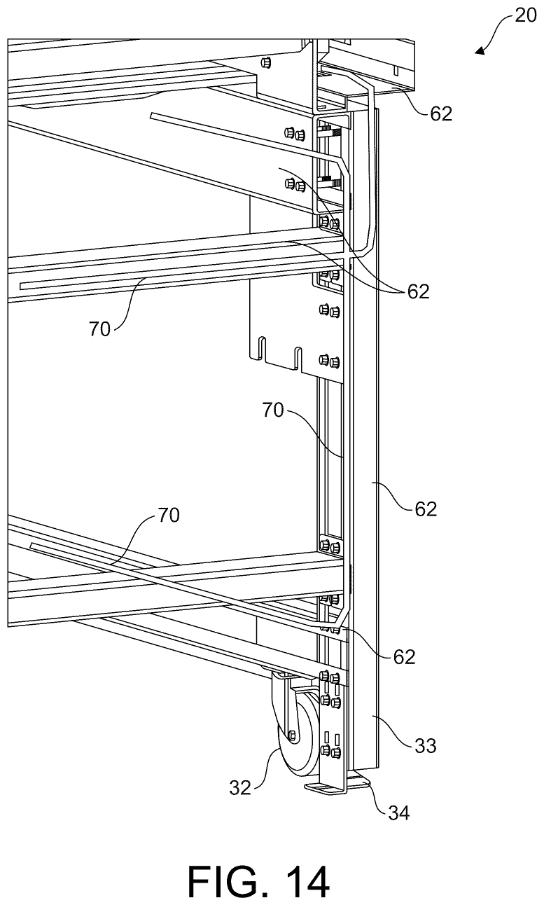

FIG. 14 shows a schematic of a partial section of a base 20 embodiment. This embodiment may be implemented with any of the structural features disclosed herein, including multiple channels 62 to provide a clear, enclosed internal space for protected wire 70 runs throughout the structure. The clear, open channels 62 provide an added level of protection, organization, and aesthetics for wiring 70 and other elements (e.g., piping) that may be needed for operation of base 20 components. In some embodiments, the wiring runs 70 consist of a cabling bundle that forms one or more buses (e.g., for electrical power distribution, signal communications).

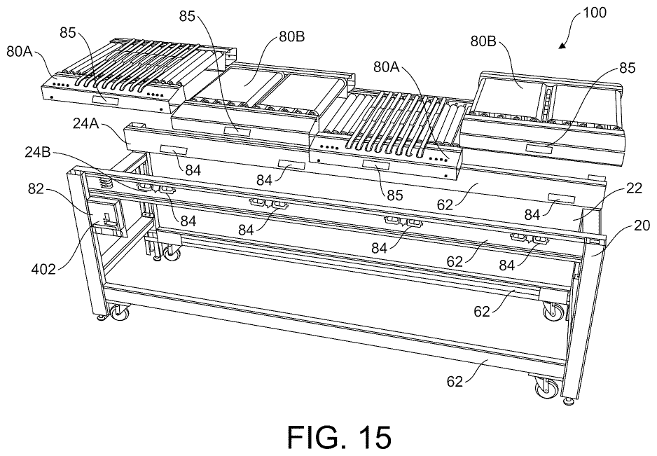

FIG. 15 shows a material handling system 100 according to this disclosure. The system 100 includes a base 20 embodiment configured to integrate a plurality of material handling modules 80A, 80B. The modules 80A, 80B are presented suspended above the base 20 platform 22 to clearly show each module as an independent unit configured to integrate onto the base 20. In this embodiment, a pair of sorter modules 80A are integrated onto the base interposed with a pair of conveyor modules 80B. It will be appreciated that any number of modules 80A, 80B may be integrated onto a base 20 depending on the length of the base 20 structure implementation. The base 20 is implemented with an integral power module 82. The upper side rails 24A, 24B are also implemented with power/signal couplings 84 to mate with counterpart power/signal couplers 85 implemented on the material handling modules 80A, 80B. The base 20 is also configured with multiple open channels 62 for wiring runs 70 as described herein. The power/signal couplers 84 on the base are linked together by wiring runs 70.

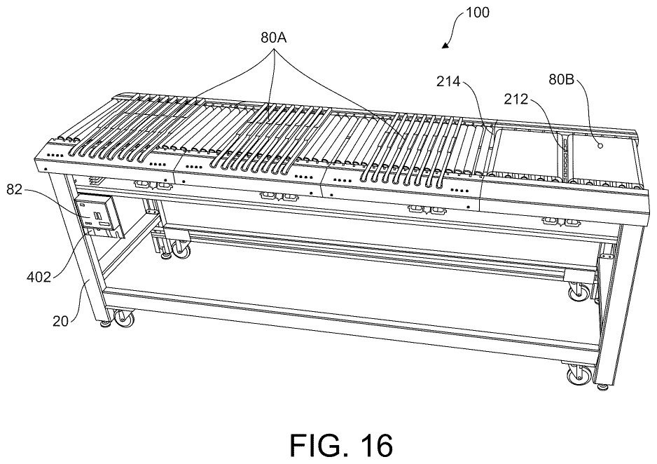

FIG. 16 shows another material handling system 100 embodiment with the modules 80A, 80B integrated onto the base 20. This embodiment is configured with a series of sorter modules 80A adjacent one another and one conveyor module 80B at one end of the base 20. It will be appreciated that system 100 embodiments may be implemented with any number of material handling modules 80A, 80B and in various combinations of module placement as desired for an application. It will also be appreciated that system 100 embodiments may be implemented with other types of material handling modules, as known in the art, integrated onto the base 20.

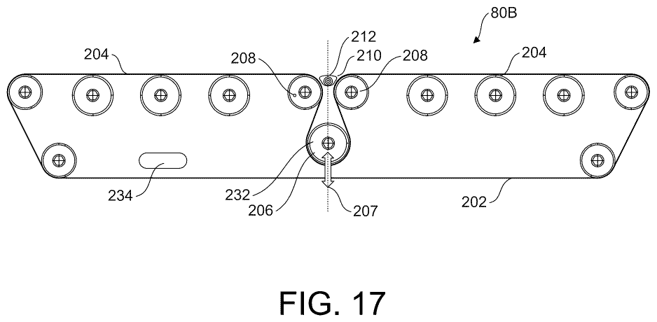

FIG. 17 shows a cross-section side view of a conveyor module 80B embodiment of this disclosure. The module 80B is implemented with a single, continuous serpentine conveyor belt 202 that provides a smooth conveyance surface 204 to move materials disposed thereon. A driver roller 206 is internally mounted near the center of the module 80B and configured for continuous automatic adjustment to provide efficient belt 202 tensioning (illustrated by arrow 207). The module 80B is also implemented with multiple idler rollers 208 to maintain a smooth, tensioned conveyance surface 204.

As shown in FIG. 17, the combined implementation of idler rollers 208 with a recessed driver roller 206 directs the continuous belt 202 to wrap around the driver roller to create a small void 210 along the conveyance surface 204 of the module 80B. The void 210 allows for positioning of a camera array 212 in the central area of the continuous belt 202 of the module 80B, where the material sensing point is optimal. With the camera array 212 disposed under the conveyance surface 204, materials passing along the conveyance surface are imaged without any exposed structural impediments to snag or obstruct the moving materials. Conventional camera arrays 212 (e.g., conventional commercial camera arrays equipped with multiple photo eye sensors) may be used in implementations of the conveyor module 80B embodiments.

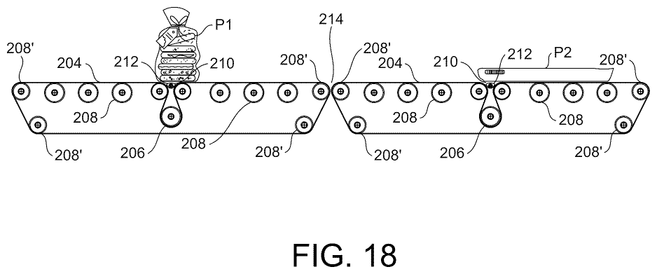

FIG. 18 shows a cross-section side view of a conveyor embodiment consisting of two conveyor modules 80B placed adjacent to one another. The modules 80B are shown apart from the base 20 for clarity of illustration. It will be understood that in operation, the modules 80B are integrated onto a base 20 as disclosed herein. In some embodiments, the conveyor modules 80B are implemented with smaller diameter idler rollers 208′ (compared to the other idler rollers 208) at each end to reduce a gap 214 between the conveyance zone formed by the side-by-side modules 80B. FIG. 18 shows an odd sized parcel P1 and a flat, package-type, parcel P2 traversing along the conveyance surface 204 formed by the adjacent modules 80B. As the parcels P1, P2 move past the void 210 in each module 80B, the respective camera array 212 detects the parcels P1, P2 indicating their presence and positioning for control of the motor(s) in each module. The arrangement of the driver roller 206 and the idler rollers 208 presents a mechanical advantage over conventional conveyor designs. The roller distribution emulates a pulley system, effectively multiplying the force of the driver roller 206 such that less mechanical effort is needed to carry or convey heavy parcels on the conveyance surface 204. The conveyor module 80B embodiments enable more efficient conveyance of heavier parcels compared to conventional platforms.

Disposing the camera 212 below the conveyance surface 204 within the module 80B belt's travel provides an improved control scheme, allowing objects P1, P2 to be stopped and detected within the belt 202 travel. There is no minimum object height requirement. By placing the camera 212 within the belt's 202 travel, all objects passing into the path of the camera lens are detected and imaged, including small, flat objects (e.g., cards, small flat envelopes, etc.). Module 80B embodiments can be implemented with different sized rollers on the ends (e.g., 208′ in FIG. 18) to custom-design the spacing of the void 210 for the camera 212 size, thereby eliminating the perils of material snags along the conveyance surface 204 while ensuring material imaging. As shown in FIG. 18, the smaller diameter rollers 208′ on the ends allow the modules 80B to be butted together, making the gap 214 very small between module zones.

Positioning of the camera array 212 is flexible by changing the roller configuration providing a control advantage over other technologies by sensing package position within the space of the module 80A, 80B.

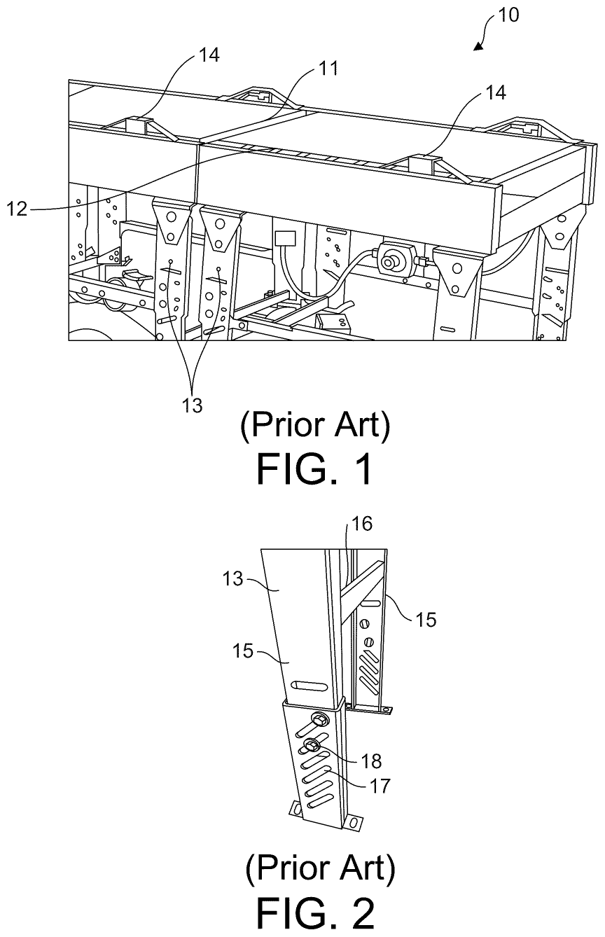

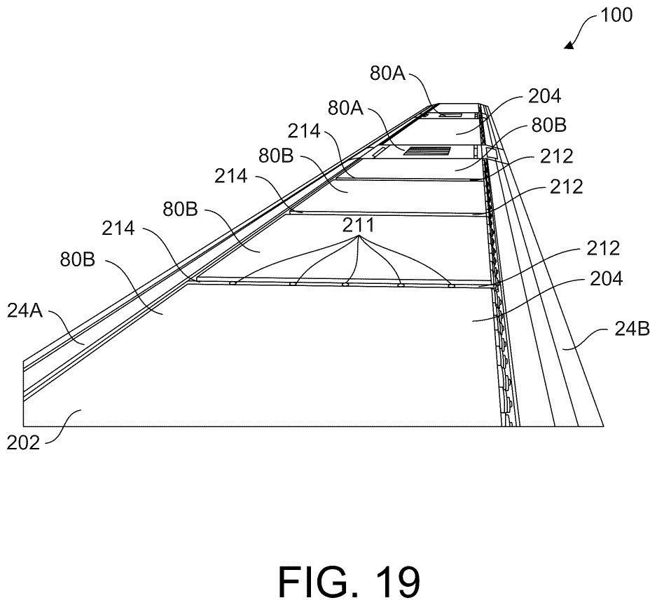

FIG. 19 shows a perspective view of a continuous conveyance surface 204 of a material handling system 100 embodiment. The system 100 is implemented with a plurality of conveyor modules 80B integrated side-by-side onto one or more bases 20 to provide a clear, unobstructed conveyance surface 204 for materials to be processed. As described above, the conveyance surface 204 provides significantly reduced gaps 214 between conveyor zones while providing a sensing capability (via the recessed camera arrays 212) along a continuous belt 202 path, without any structures above the belt surface (see e.g., cameras 14 in FIG. 1). The system 100 ability to sense at multiple positions along a single conveyor zone enables true zone control without side rails or side-mounted detectors, which often fail with envelopes or low-profile parcels in conventional systems. The system 100 embodiment of FIG. 19 is also configured with one or more sorter modules 80A integrated onto the base 20 along the conveyance surface 204. The sorter modules 80A may be configured to automatically divert selected materials off the conveyance path 204 based on identification data obtained via one or more of the photo eye sensors 211 in a camera array 212 embodiment and/or other cameras disposed on the system 100 structure (further described below).

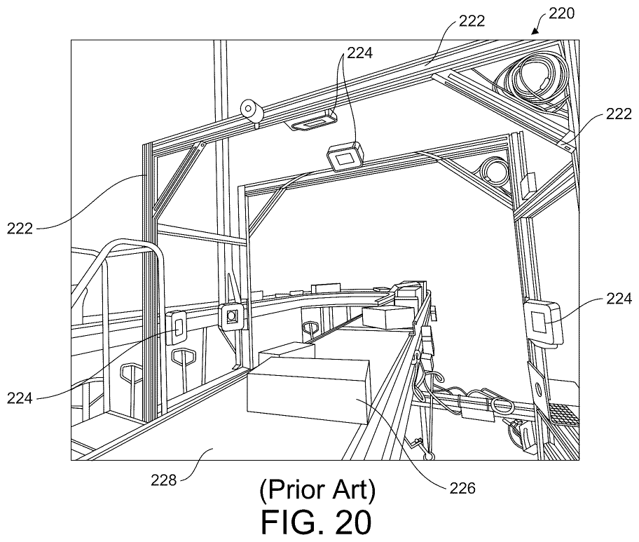

FIG. 20 shows a conventional parcel sorting station 220. The station 220 structures 222 for mounting and aligning scan cameras 224 consist of large, rigid frames to provide for camera placement at the necessary field of view distance and working distance to the box or parcel 226 on the conveyor 228. A drawback of conventional stations 220 is that the cameras 224 often miss detection of objects having a low profile (e.g., polybags, envelopes, etc.). The station 220 frame structures 222 are large compared to the conveyor 228 frame, resulting in oversized structures relative to the conveyor frame, leading to difficulties in transportation, setup, and overall integration within operating environments.

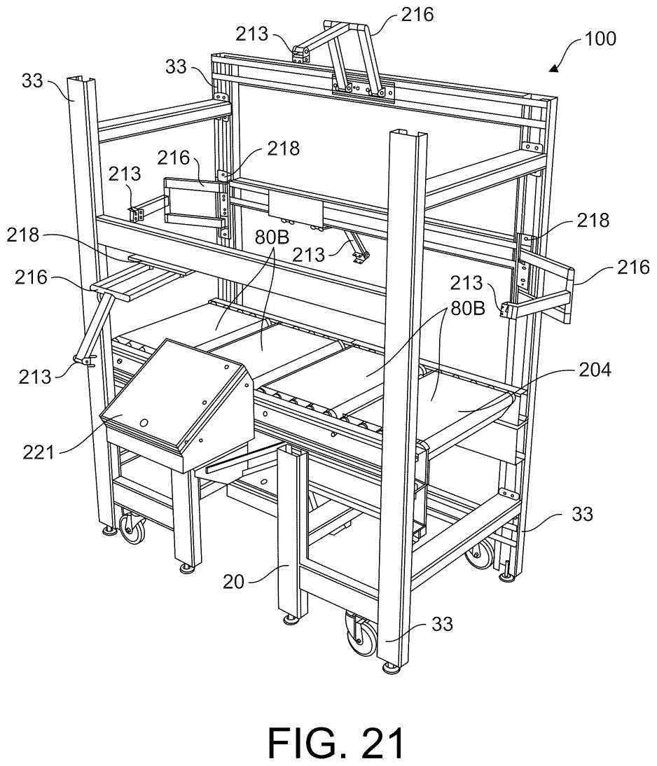

FIG. 21 shows a schematic of another material handling system 100 embodiment of this disclosure. The base 20 may be implemented with all of the features disclosed herein for base embodiments. However, the legs 33 on this base 20 are extended in length to enable the mounting of additional cameras 213 at various working distances from the conveyance surface 204 formed by the plurality of conveyor modules 80B. The system 100 frame is implemented with the adjustable frame connections 50 disclosed herein. This provides the advantage of reducing the size of the main frame to the structure within the base 20 conveyor frame while allowing the mounting of cameras 213 to provide the desired fields of view and working distances.

The system 100 is also implemented with articulated arms 216 that permit mounting the cameras 213 to extend well beyond the overall frame height and width on either end, providing a virtual 360 degree imaging capability (including the module 80B camera arrays 212) along the conveyance surface 204. The articulated arms 216 provide a multi-axes positioning platform for precise alignment of the cameras 213 or any other devices coupled to the arms as needed for a particular operation or environment. The articulated arms 216 are also affixed to linear actuators 218 to further allow for camera 213 adjustment in both vertical and horizontal directions. The articulated arms 216 can be folded in to reduce the system 100 structure size for movement, shipping, and deployment at desired operating environments. The system 100 of FIG. 21 is also implemented with a stow-away operator control panel 221 (further described below).

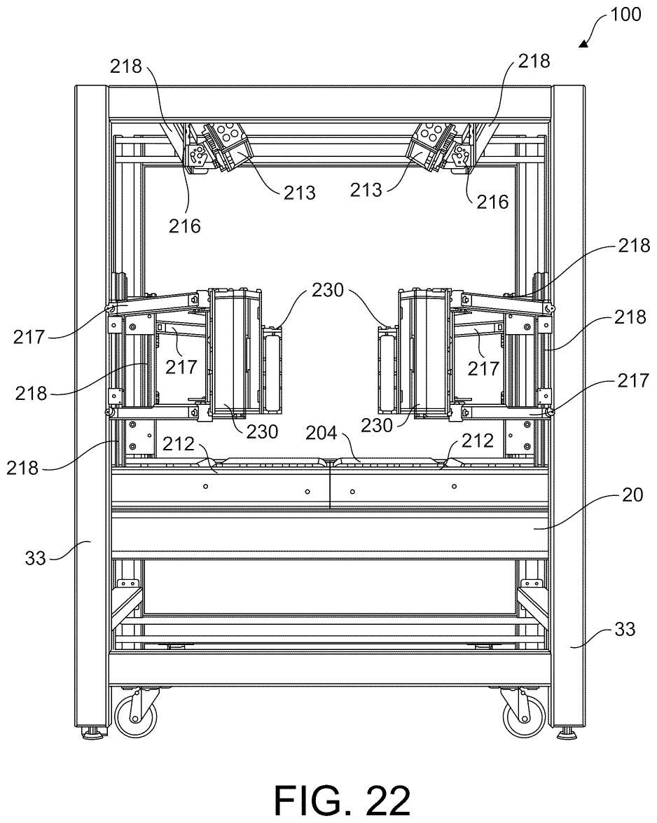

FIG. 22 shows another material handling system 100 embodiment of this disclosure. The base 20 and overall frame structure may be implemented with all of the features disclosed herein for base and system embodiments. This system 100 includes a pair of cameras 213 mounted on multi-axes articulated arms 216 disposed above the conveyance area 204. As shown in FIG. 22, the base 20 legs 33 in this embodiment are extended to provide an elevated support structure for the articulated arms 216 and cameras 213. Some embodiments may also be implemented with linear actuators 218 to permit for automated precise adjustment of the respective camera's 213 field of view. The cabling and wiring for the cameras 213 and other apparatus on the system 100 are run via wire runs 70 through the hollow-channel frame structures as disclosed herein (see FIG. 14).

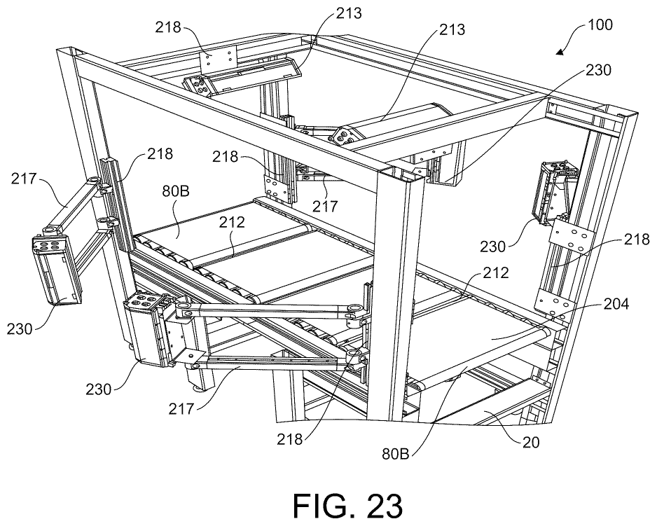

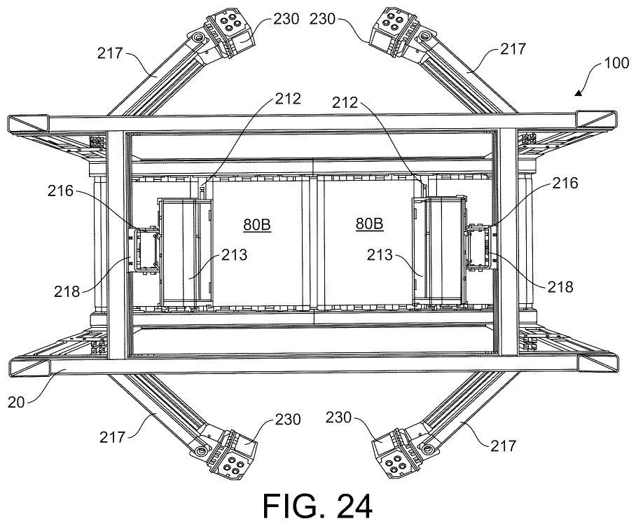

The system 100 in FIG. 22 is also implemented with four articulated swing arms 217, with one swing arm extending from each elongated leg 33. These arms 217 may be used to support any peripheral apparatus 230 (e.g., cameras, sensors, video monitors, touch control panels, etc.). The articulated swing arms 217 may also be coupled to linear actuators 218 to permit for height adjustment as desired by an operator. FIG. 23 shows an elevated view of the system 100 of FIG. 22. FIG. 24 shows an overhead view of the system 100 of FIG. 22, with the articulated swing arms 217 extended.

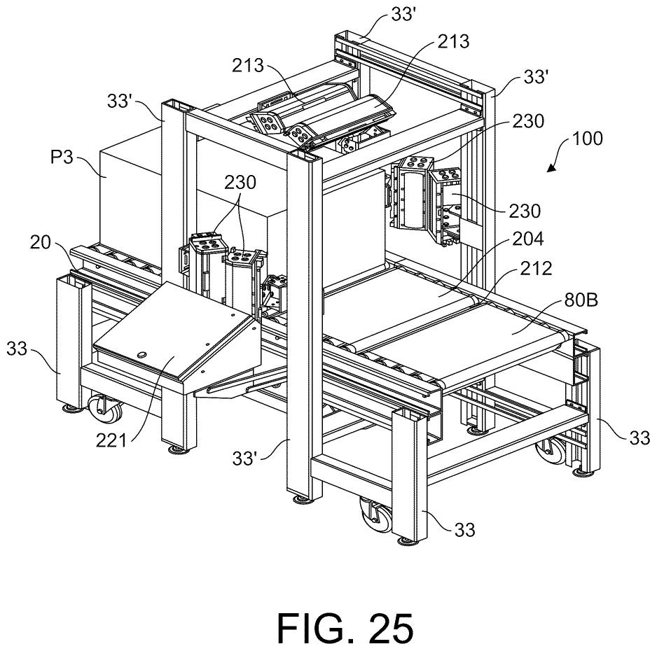

FIG. 25 shows another material handling system 100 embodiment of this disclosure. The base 20 and overall frame structure may be implemented with all of the features disclosed herein for base and system embodiments. This system 100 is implemented with a base 20 configured with extended legs 33′ stemming upward from a central section of the base to provide an elevated frame structure to suspend upper cameras 213. The outer ends of the base 20 are configured with shorter legs 33 compared to the central section. As shown in FIG. 25, the cameras 213 and peripheral apparatus 230 can be retracted on the frame structure to provide a clear and unobstructed path for large parcels P3 traversing on the conveyance area 204. Some embodiments may also be implemented with a stow-away operator control panel 221.

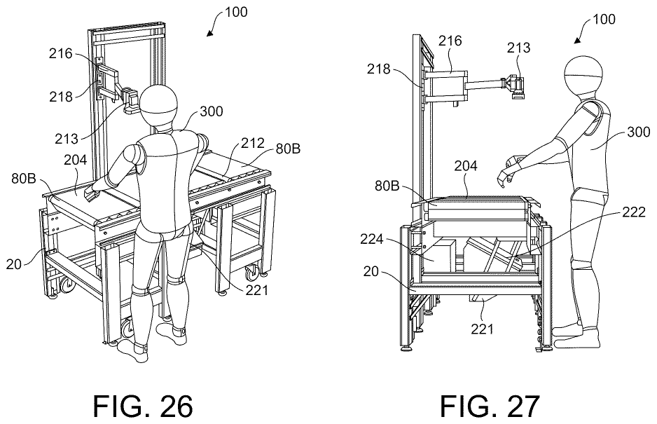

FIG. 26 shows a schematic of another material handling system 100 embodiment of this disclosure. The base 20 and overall frame structure may be implemented with all of the features disclosed herein for base and system embodiments. As shown in FIG. 26, the disclosed systems 100 provide a significant reduction in structural size compared to conventional sorting stations (see FIG. 20). The overall system 100 footprint is reduced to practically the width of the material handling modules 80A, 80B integrated onto the base 20. FIG. 26 shows an embodiment implemented with a stow-away operator control panel 221. The panel 221 is shown in the recessed or stowed position, permitting an operator 300 fully unobstructed access to the conveyance surface 204 and accessibility to the cameras 213 for adjustments as desired.

FIG. 27 shows a side view of the system 100 of FIG. 26, providing a better view of the control panel 221 in the stored position. Articulated arms 222 couple the panel 221 to the base 20. As illustrated in FIG. 27 and as described herein, the disclosed system 100 embodiments enable rapid and easy frame adjustments to be made as desired so that different operators 300 can run the system safely and comfortably. For example, the height of the base 20 may be easily raised or lowered via the closed channel frame connections 50 to accommodate operators 300 of any height. The articulated arms 216 suspending the camera 213 on the frame structure allow for multi-axes adjustment. And the linear actuator 218 permits height adjustment of the camera 213 to achieve the necessary field-of-vision and working distance for scanning materials in motion or stationary on the module 80A, 80B conveyance surface 204. The system 100 embodiment of FIG. 14 is also implemented with an independent power supply module 224 (e.g., battery).

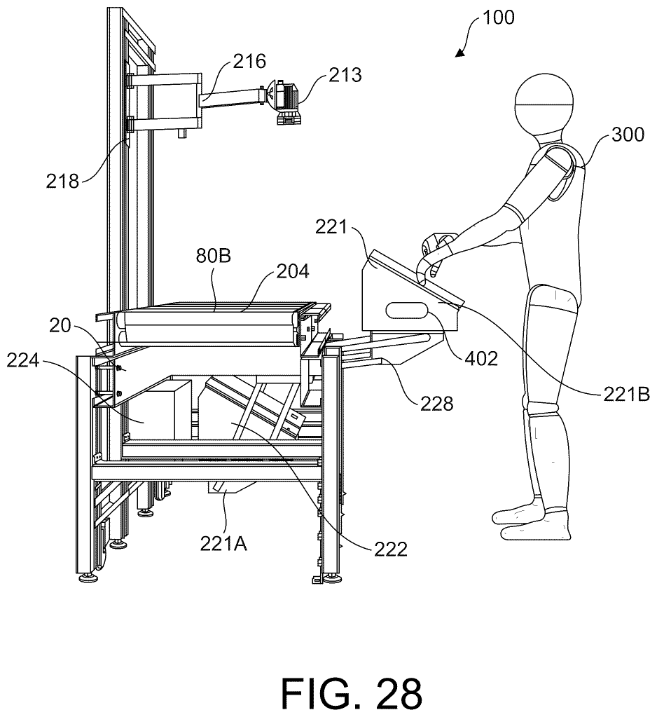

FIG. 28 shows another side view of the system 100 of FIG. 26. The figure shows the control panel 221 in the stored position 221A and in the extended or interaction position 221B for operator 300 use. The articulated arms 222 permit the operator 300 to adjust how far out from the base 20 and the height to extend the control panel 221. In some embodiments, the articulated arms 222 are configured with a conventional locking mechanism 228 to allow the operator 300 to lock the control panel 221 at the desired extension and height. This flexibility provides easy controls access to all operators 300 (e.g., people using wheelchairs).

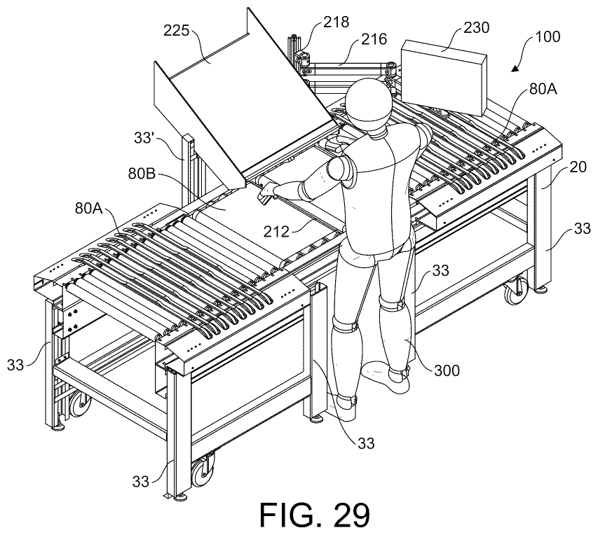

FIG. 29 shows another material handling system 100 embodiment of this disclosure. The base 20 and overall frame structure may be implemented with all of the features disclosed herein for base and system embodiments. This system 100 is implemented with a base 20 configured with extended legs 33′ stemming upward from the rear central section of the base to provide an elevated frame structure to suspend a slide 225. In operation, the slide 225 is typically linked to a chute (not shown) to funnel parcels and materials onto the slide 225. With the slide 225, an operator 300 can quickly guide a parcel onto the conveyor module 80A for scanning via the camera array 212 in the module. As shown in FIG. 29, the other legs 33 of the base 20 are shorter compared to the legs 33′ in the rear central section.

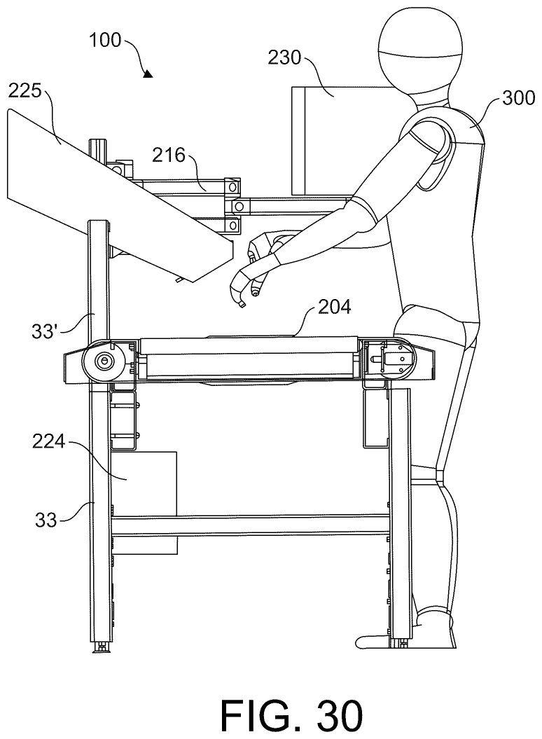

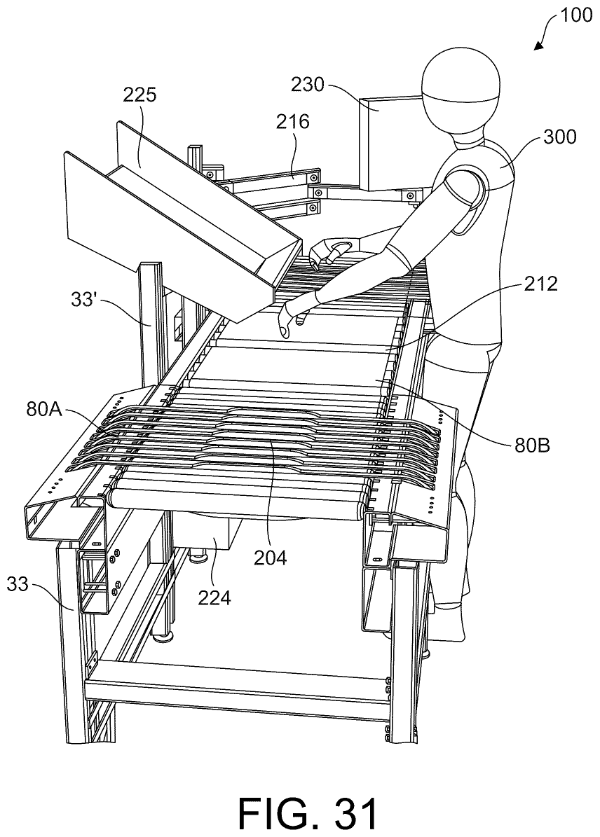

FIG. 30 shows a side view of the system 100 of FIG. 29. As described herein, the disclosed system 100 embodiments enable rapid and easy frame adjustments to be made as desired so that different operators 300 can run the system safely and comfortably. For example, the height of the base 20 may be easily raised or lowered via the closed channel frame connections 50 to accommodate operators 300 of any height. In some embodiments, the base 20 may also be configured with an independent power supply module 224 (e.g., battery). FIG. 31 shows an elevated perspective view of the system 100 of FIG. 29.

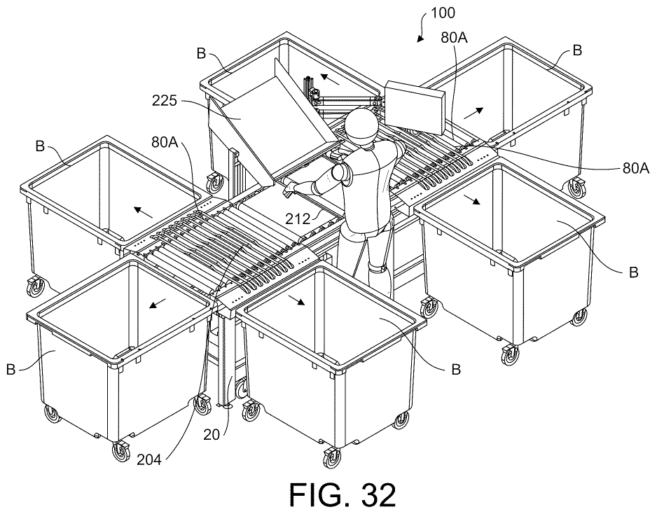

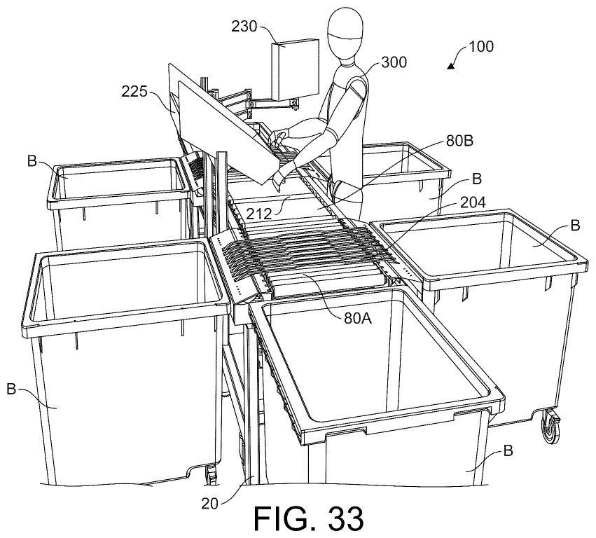

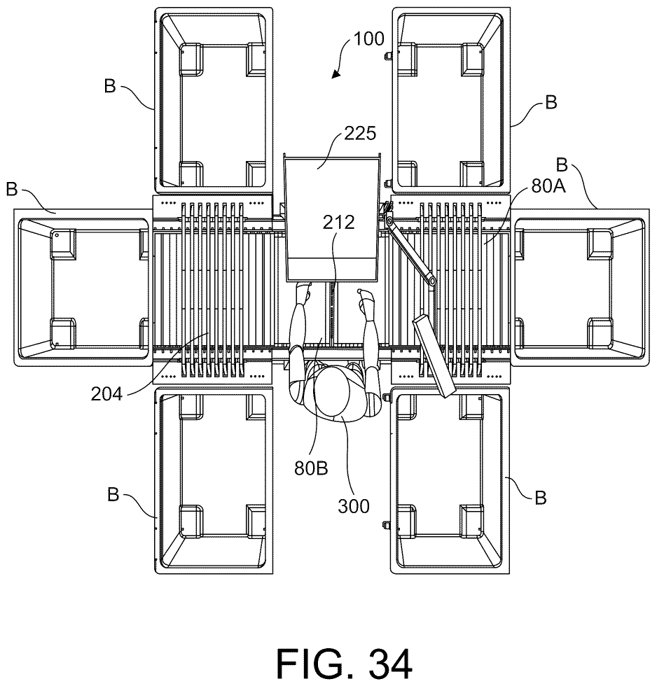

FIG. 32 shows an elevated view of the system of FIG. 29 in a working environment. The base 20 is shown surrounded by bins B to receive materials traversing on the conveyance surface 204. The materials are dispersed into the respective bin B as designated by the base 20 power supply 82 and dispensed via the sorter modules 80A (further describe below). FIG. 33 shows a perspective view of the system 100 of FIG. 32. FIG. 34 shows an overhead view of the system of FIG. 32.

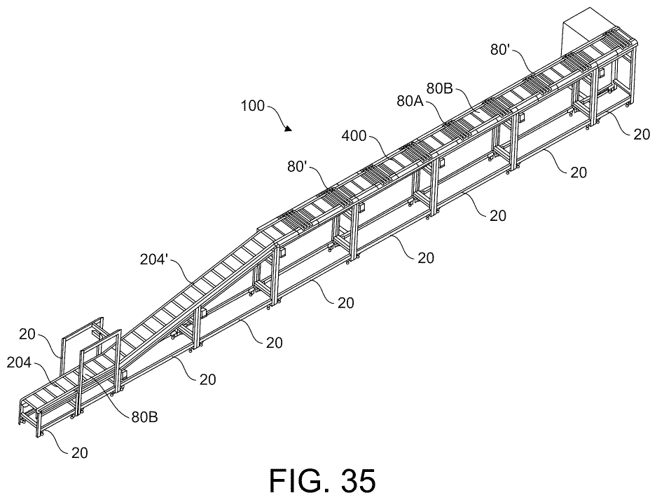

FIG. 35 shows a system 100 embodiment forming a material handling line of coupled bases 20 equipped with material handling modules 80A, 80B. The portable modular system 100 base 20 units can be linked together to form any desired configuration. The adjustability of the base 20 frame connections 50 facilitates the arrangement of assemblies with angled conveyance surfaces 204′ at any desired position along the assembly, as shown in FIG. 35. This rapid and easy structural adjustability of the bases 20 also permits arrangement of a system 100 with sections having different heights. FIG. 35 also shows a communication network 400 linking the coupled bases 20 via the wire 70 runs in the bases. The network 400 allows for power/signal communication via the respective buses in the wire 70 runs.

FIG. 36 shows a perspective view of the system 100 of FIG. 35, The system 100 is arranged with base 20 units at one height H1 at one end and at a different height H2 at the other end. It will be appreciated that system 100 assemblies may be configured with bases 20 including multiple conveyor modules 80B and any other types of material handling modules 80′ as known in the art. The base 20 embodiments can also be implemented in different lengths to accommodate the space availability in the operating environment.

As described above, the material handling modules 80A, 80B are equipped with drive roller motors 216 (see FIG. 17) that receive power and signal communications via the module couplers 85 mating with the base 20 couplers 84 when the modules are integrated onto the base. The system 100 embodiments are able to configure themselves when the modules 80A, 80B are integrated onto the base 20. In some embodiments, the module 80A, 80B motors 216 include a firmware microprocessor 232 (see FIG. 17) storing the respective motor's unique identifier data and control protocols. The identifier data includes the respective module's 80A, 80B functionality (e.g., sorter, conveyor, etc.). Upon integration of the module(s) 80A, 80B onto the base 20, the power supply 82 automatically reads the identifier data and control protocols in each motor 216 and identifies the type of module (e.g., sorter, conveyor, etc.). The base 20 controller 82 software is thus configured to automatically communicate with and control all of the modules 80A, 80B integrated onto the base 20.

In some system 100 embodiments, the modules 80A, 80B are implemented with firmware 234 (see FIG. 17) storing unique identifier data for all components and control protocols on the respective module. Upon integration of the module(s) 80A, 80B onto the base 20, the base power supply 82 automatically reads the identifier data and control protocols in each module and identifies the type of module (e.g., sorter, conveyor, etc.). The system controller software automatically communicates with and controls all of the modules 80A, 80B.

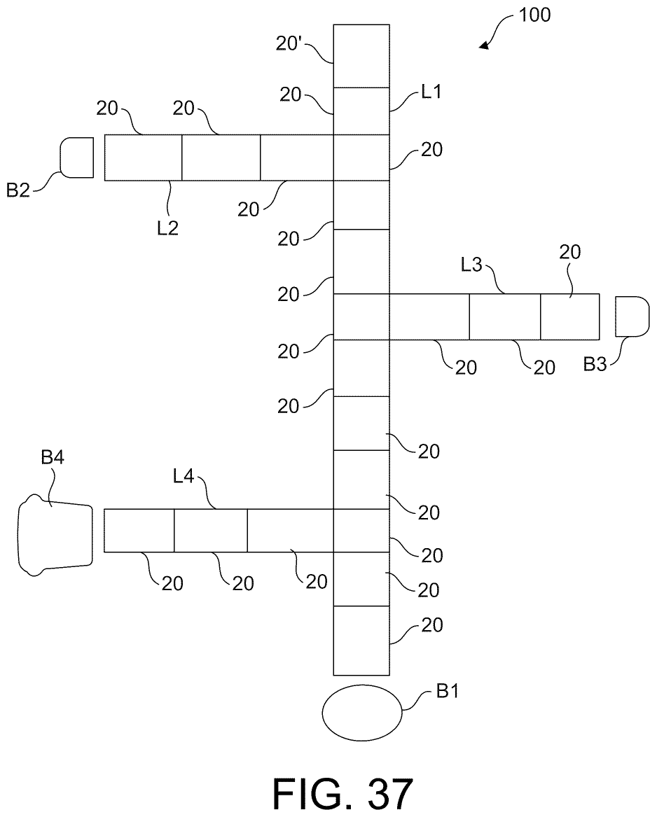

FIG. 37 shows an overhead schematic of a material handling system 100 embodiment having one main line L1 and multiple branch lines L2, L3, L4. The channeled frame connections 50 of the base 20 embodiments enable quick and easy coupling and decoupling of the respective base 20 unit frame members forming the system 100. The system 100 is shown including receiving bins B1, B2, B3, B4 respectively placed at the end of each branch line L1, L2, L3, L4. It will be appreciated that receiving bins B1-B4 can be any receptacle/conveyance apparatus as known in the art.

Sortation systems 100 such as shown in FIG. 37 can be implemented with each base 20 unit configured with its own controller module 82 to perform the configuration functions described above. Alternative system 100 embodiments configured with multiple base 20 units, such as shown in FIG. 37, may also be implemented with a number of “drone” base 20 units that are not configured with their own independent power module 82. In such systems 100, the one or more base units implemented with a controller module 82 (e.g., 20′ in FIG. 37) are configured to automatically read the identifier data and control protocols in each module in the system via the communication network 400 (see FIG. 35) established by the coupled base 20 units. In this manner, the base 20 power module 82 software automatically communicates with and controls all of the modules 80A, 80B in the multi-base system 100.

As described above, an operator can control the operation of each module 80A, 80B in a system 100 via a control panel 221. “Control” in this sense means control of the configuration and actuation of each module 80A, 80B in the system 100. For example, with reference to FIG. 37, an operator can program (via a touch screen on the control panel 221) the modules 80A, 80B in each branch line L1, L2, L3, L4 for actuation to automatically convey and distribute materials (e.g., parcels, bags, loose items, boxes, etc.) for distribution into specified bins B1, B2, B3, B4 as desired. For example, the system 100 can be configured to distribute boxes of a set minimum dimension to be conveyed along branch lines L1 and L2 for distribution into bin B2. The cameras 213 on the base(s) 20 and/or the camera arrays 212 in the modules 80B in the branch lines L1 and L2 would then track the conveyance of such boxes along the lines to automatically actuate the sorter modules 80A in lines L1 and L2 to convey the boxes to bin B2.

In some system 100 embodiments an operator can program the coupled bases 20 in the system to automatically perform different conveyance operations based on the type of material object identified on the conveyance surface 204 by the cameras 212, 213 respectively disposed on the frame structures and in the conveyor modules 80B. An electronic database compilation of different material objects can be stored in non-volatile memory on one or more of the processors 402 in the system controller(s) and/or in the control panel 221. Such databases can easily be updated as desired via software as known in the art.

The communication network 400 formed by the module-base couplers in each base 20 enables a controller in the system 100 to automatically identify each module 80A, 80B integrated into the system and to automatically configure system operation. For example with a system 100 such as shown in FIG. 37, the controller(s) 82 can be programmed to automatically perform conveyance run 1 (e.g., along branch lines L1 and L4), or conveyance run 2 (e.g., along branch line L1 and L2), or conveyance run 3 (e.g., along branch lines L1 and L3), or conveyance run 4 (e.g., solely along branch line L1) depending on the modules 80A, 80B identified upon integration and the programming previously set by an operator via the control panel 221.

As known by those skilled in the art, conventional motorized drive rollers (such as motors 206) require specific programs or subroutines to control the motor for operation of each specific module type (e.g., 80A, 80B, 80′). Since the modules 80A, 80B, 80′ provide different functions (e.g., in-line, transverse, and/or diagonal material conveyance), it is important to identify the type of motor(s) 206 in each module so that the proper subroutines are called and applied to properly operate the module and therefore the entire system 100.

Some system 100 embodiments create a database or lookup table to keep track of the motor(s) 206 housed in each module 80A, 80B, 80′. By correlating the motor(s) 206 in each module 80A, 80B, 80′ with the particular functions of the module, a system 100 can be quickly configured by identifying the motor(s) in each module. One way to log the data is to correlate each motor 206 in the module 80A, 80B, 80′ with the data uniquely associated to the functions of the respective module. Each motor's 206 unique serial number provides an efficient means to identify and track the motors.

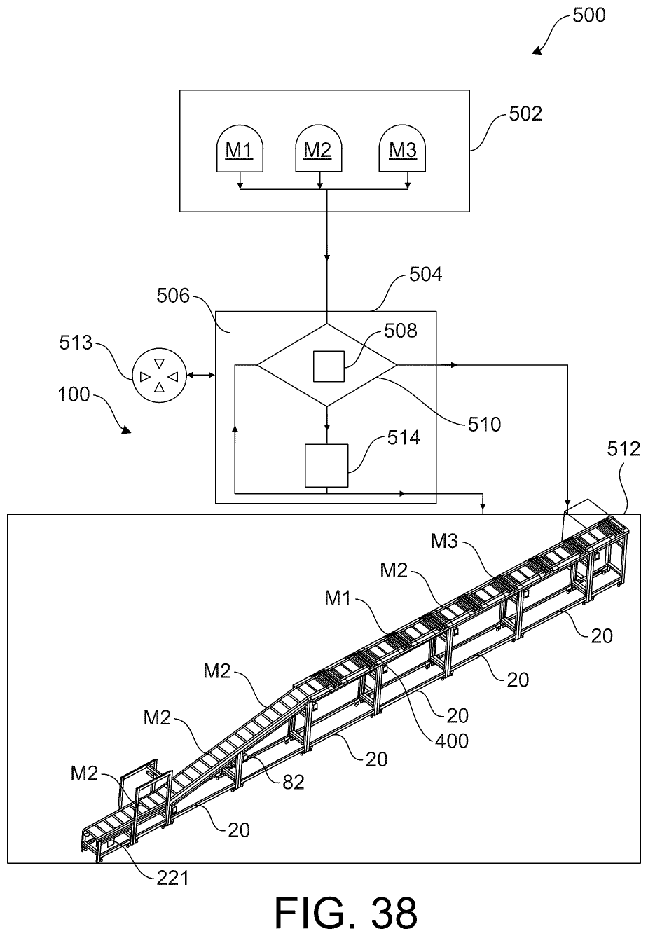

FIG. 38 shows an architecture and process flow chart 500 of a system 100 embodiment of this disclosure. At step 502, one or more material handling modules M1 (e.g., 80A), M2 (e.g., 80B), M3 (e.g., 80′) are selected for integration onto one or more base 20 embodiments. At step 504, a designated central microprocessor 506 in the system 100 (e.g., 234, 402) has been programmed to recognize the digital data correlated to each motor 206 in each selected module M1, M2, M3. The central microprocessor 506 compares the recognized motor data against a digital database or “lookup table” 508 populated and stored in memory 510 linked to the microprocessor 506. The database may be populated prior to integration of the respective modules M1, M2, M3 onto the base(s) 20 (e.g., by uploading and linking the motor and functionality data associated with each selected module), or the microprocessor 506 may be programmed to automatically recognize the digital motor data once the module is integrated onto the base(s). Once the motor 206 identifier data is recognized and associated with the respective module M1, M2, M3, the respective function(s) of the module is identified and step 512 occurs. At step 512, the central microprocessor 506 has been programmed to automatically call the appropriate subroutines (stored in memory 510) necessary to operate the motor(s) 206 to run the module. By performing this digital motor-module-function correlation, the central microprocessor 506 can autonomously and automatically configure its programs to operate all integrated system 100 modules M1, M2, M3 in the order detected and automatically reprograms its function when modules are added and removed from the base(s) 20, all of which can be preprogrammed by an operator as desired.

At step 504, if the digital data correlating a motor 206 in a selected modules M1, M2, M3 to the module's function is not found or recognized in the lookup table 508 by the central microprocessor 506, step 514 occurs. At step 514, the microprocessor 506 triggers an alert notifying that the respective motor 206/module M1, M2, M3 function data is not found in the lookup table 508. An operator can then add the missing data to the lookup table 508 or make the desired control adjustments (e.g., via the control panel 221). Once the missing data is added to the lookup table 508 or the operator makes a selected control adjustment, step 512 ensues and automatic system 100 configuration takes place as described herein. Electronic signal communication between the motors 206, the motor microprocessors 232, other module M1, M2, M3 components, other processors 234, 402 in the system 100, and the central microprocessor 506 is conducted via the system 100 communication network 400.

System 100 embodiments may also be configured to permit remote base 20, module 80A, 80B, 80′, and/or camera 212, 213 operation and programming by an operator via conventional wireless communication technology as known in the art (e.g., by an operator with an app on a mobile device). The system 100 microprocessor(s) 234, 402 thus enable operators to design customized material handling and control schemes as desired for a particular arrangement. Some system 100 embodiments may also be implemented with conventional artificial intelligence software 513 uploaded to the controller(s) and/or control panel 221 microprocessors in the system to automatically and autonomously perform the module 80A, 80B, 80′ recognition, identification, configuration, and sorting control schemes as well as trigger alerts, perform emergency shut downs, decipher labeling on parcels in multiple languages, etc.

The software constructs enabling the embodiments of this disclosure reside in the non-transient memory of one or more conventional microprocessors 232, 234, 402, 508 in the system 100 controller(s), modules 80A, 80B, 80′, and/or system control panel(s) 221. Embodiments of the software code may be implemented using conventional programming languages as known in the art (e.g., JAVA™, PYTHON™, C, C++, etc.). It will be appreciated by those skilled in the art that the microprocessors/controllers may be implemented with a single software program or a group of programs designed to perform the activities of the disclosed embodiments. The computing architecture may be implemented with conventional computer hardware and electronics as known in the art.

The disclosed system 100 embodiments provide modularity and efficiency at a new level. Advantages of the base 20 embodiments include frame structures with articulated arms and adjustability in multiple axes. The frame structures enable segments to fold out for additional distance from mounted cameras to the scanned materials moving or loaded on the conveyance surfaces. The easy coupling enabled by the channeled frame connections 50 enable highly configurable systems 100 of material handling bases 20. The integration of various material handling modules t80A, 80B, 80′ onto a power base 20 allows for an unprecedented range of control capabilities and thousands of configurations.

The overall system 100 design provides for fast deployment, with mobile base 20 modules that easily couple together for simple or complex material handling arrangements. The streamlined base 20 embodiments provide the folding capabilities for mobility, easy shipment, and fast on-site set-up. The modular base 20 designs enable seamless alignment of multiple base units with material handling modules 80A, 80B, 80′ to form a complete system, including induction, scanning, and sorting functions. Base 20 embodiments may be implemented with optional permanent or temporary wheels or casters, facilitating mobility for relocation or scheme reconfiguration. The base 20 embodiments are engineered to integrate various combinations of conveyance 80A, sortation 80B, and other 80′ modules without drilling, pre-drilled holes, or slots. Base construction ensures fine adjustments to address discrepancies in fabrication, delivering a consistently plumb, level, and stable platform. The system 100 embodiments enable straightforward base transport, plug-and-play module integration, power connections, system communication, and automatic configuration, simplifying setup, minimizing downtime, and significantly reducing costs compared to conventional stations. The base 20 embodiments are also compatible for integration with conventional conveyor systems, offering a reduced overall footprint and simplified integration process providing a clear path for scaling.

Other system 100 advantages include innovative sorter module 80B camera 212 mounting to provide clear and unencumbered material conveyance paths. The material handling modules 80B with below-conveyance-surface cameras 212 provide for obstacle-free motion path conveyance. The base 20 frames provide articulated linear and multi-axes (X, Y, Z) adjustability for precise camera and monitor alignment. The articulated frame structures can fold inward, minimizing base 20 size for easier transportation and maneuverability within areas of limited space. The reduction of material use and streamlined construction, compared to conventional sortation systems, lower manufacturing and operational costs without sacrificing functionality. The system 100 control software can automatically and autonomously recognize the module arrangements and auto-configure for improved material handling and conveyance control.

In light of the principles and example embodiments described and illustrated herein, it will be recognized that the example embodiments can be modified in arrangement and detail without departing from such principles. For example, alternative embodiments may include base 20 units that use fewer or additional components compared to what is disclosed herein. It will also be appreciated that the disclosed embodiments may be implemented using conventional commercial materials, electronics, hardware, and apparatus. The individual structural members used to implement system embodiments may also be formed of suitable materials (e.g., metal, composites, plastics, etc.).

What is claimed is:

1. A material handling system, comprising:
a base configured to integrate a plurality of material handling modules;
each material handling module housing at least one motor correlated to digital data uniquely associated to the function of the respective module;
at least one processor configured with instructions to:
a) recognize the digital data correlated to each at least one motor in each module;
b) process the recognized digital data to identify the function of each respective module;
c) enable actuation of each module based on the identified function of the respective module;
the base configured with a communication network to permit digital data transfer between the at least one processor and each material handling module,
wherein the at least one processor is configured to automatically perform the instructions (a)-(c) when a material handling module is integrated onto the base.

2. The system of claim 1, wherein at least one of the material handling modules comprises a conveyor module providing a conveyance surface to move materials disposed thereon, and a camera disposed beneath the conveyance surface to provide an unobstructed conveyance path and detect materials disposed on the conveyance surface.

3. The system of claim 2, wherein the conveyor module having a camera disposed thereon comprises a single continuous conveyor belt to provide the conveyance surface, with the camera disposed in a gap formed in the belt.

4. The system of claim 3, wherein the camera comprises an array of optical elements configured to image the materials disposed on the conveyance surface without limitation of the height of the materials.

5. The system of claim 1, wherein the at least one processor is configured to process the recognized digital data to identify the function of each respective module by comparison of the recognized digital data against data in a digital lookup table.

6. The system of claim 1, wherein the at least one processor is communicatively linked to an artificial intelligence engine configured to perform selective operations.

7. The system of claim 1, wherein the base comprises at least one structural component configured to fold to alter the physical configuration of the base.

8. The system of claim 7, wherein the base comprises at least one structural component configured to permit adjustment in length and/or slope.

9. The system of claim 8, wherein the base is configured with wheels to enable mobility.

10. The system of claim 7, wherein the base is configured with at least one structural component configured to hold a camera to image materials disposed on at least one material handling module integrated onto the base.

11. The system of claim 1, wherein the base is configured to integrate the plurality of material handling modules in an arrangement to provide zones with different material handling capabilities.

12. The system of claim 1, wherein the at least one processor resides in a control panel disposed on the base.

13. The system of claim 12, wherein the control panel is configured to be stowed away in the base and extended from the base via a moveable member coupled between the panel and the base.

14. The system of claim 1, wherein the base is configured to link with one or more bases also configured to integrate a plurality of material handling modules thereon, to provide a selectively configurable material handling system.

15. The system of claim 1, wherein the base is configured with a power bus to provide electrical power to each material handling module integrated onto the base.

16. A method for handling materials, comprising:
integrating a plurality of material handling modules onto a base,
wherein each material handling module houses at least one motor correlated to digital data uniquely associated to the function of the respective module;
using at least one processor configured with instructions to:
a) recognize the digital data correlated to each at least one motor in each module;
b) process the recognized digital data to identify the function of each respective module;
c) enable actuation of each module based on the identified function of the respective module;
providing a communication network on the base to permit digital data transfer between the at least one processor and each material handling module,
automatically performing the instructions (a)-(c) via the at least one processor when a material handling module is integrated onto the base.

17. The method of claim 16, wherein at least one of the material handling modules comprises a conveyor module providing a conveyance surface to move materials disposed thereon, and a camera disposed beneath the conveyance surface to image materials disposed on the conveyance surface.

18. The method of claim 17, wherein the conveyor module having a camera disposed thereon comprises a single continuous conveyor belt to provide the conveyance surface, with the camera disposed in a gap formed in the belt.

19. The method of claim 18, wherein the camera comprises an array of optical elements configured to image the materials disposed on the conveyance surface.

20. The method of claim 16, wherein the at least one processor is configured to process the recognized digital data to identify the function of each respective module by comparison of the recognized digital data against data in a digital lookup table.

21. The method of claim 16, wherein the at least one processor is communicatively linked to an artificial intelligence engine configured to perform selective operations.

22. The method of claim 16, wherein the base comprises:
at least one structural component configured to fold to alter the physical configuration of the base;
at least one structural component configured to permit adjustment in length and/or slope; and
wheels to enable mobility.

23. The method of claim 22, wherein the base is configured with at least one structural component configured to hold a camera to image materials disposed on at least one material handling module integrated onto the base.

24. The method of claim 16, wherein the base is configured to integrate the plurality of material handling modules in an arrangement to provide zones with different material handling capabilities.

25. The method of claim 16, wherein the at least one processor resides in a control panel disposed on the base.

26. The method of claim 25, wherein the control panel is configured to be stowed away in the base and extended from the base via a moveable member coupled between the panel and the base.

27. The method of claim 16, further comprising linking the base with one or more other bases also configured to integrate a plurality of material handling modules thereon, to provide a selectively configurable material handling system.

28. A material handling system, comprising:
a base configured with at least one material handling module consisting of a conveyor module configured with a single continuous conveyor belt to provide a conveyance surface to move materials disposed thereon; and
the at least one conveyor module configured with a camera disposed beneath the conveyance surface to provide an unobstructed conveyance path and image materials disposed on the conveyance surface without limitation of the height of the materials,
wherein the camera is disposed in a void formed in the single continuous conveyor belt.

29. The system of claim 28, wherein the base is configured with multiple cameras disposed beneath the conveyance surface to sense materials at multiple positions along a single conveyance zone.

30. A material handling system, comprising:
a plurality of independent material handling modules;
a base configured to receive the plurality of modules; and
at least one processor configured with instructions to identify the function of each respective module of the plurality of material handling modules to enable plug-and-play integration of the plurality of modules onto the base.
